(19) United States
(12) Patent Application Publication
(10) Pub. No.: US 2008/0104307 A1
(43) Pub. Date: May 1, 2008

(54) Multi-sector to single-sector request mapping

(76) Inventor: Robert M. Van Rooyen, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/591,250

(22) Filed: Oct. 31, 2006

(51) Int. Cl. G06F 12/00

(52) U.S. Cl. 711/103

(57) ABSTRACT

One embodiment relates to a method of performing a multi-sector memory request for data to be communicated with a memory device. The multi-sector memory request is received. The multi-sector memory request received includes a starting sector address and a number of sectors to be communicated. The multi-sector memory request is mapped into a series of single sector memory requests. The single sector requests are submitted to the memory device. Other embodiments are also disclosed.

### BACKGROUND

1. Field of the Invention

The present invention relates generally to methods and apparatus for computer networking and other applications.

2. Description of the Background Art

Apparatus for computer networking and other applications often utilize memory storage systems. More particularly, a flash memory storage system is often utilized.

Conventionally, a flash memory storage system includes a flash memory controller and flash memory media. The flash memory controller is used to interface with and control flash memory media. More particularly, the flash memory controller controls writes to and reads from the flash memory media.

Sometimes, a flash memory storage system may be unreliable. In particular, multi-sector reads and multi-sector writes may fail to perform properly and result in errors.

It is highly desirable to improve the reliability and robustness of flash memory storage systems and their utilization.

### SUMMARY

One embodiment relates to a method of performing a multi-sector memory request for data to be communicated with a memory device. The multi-sector memory request is received. The multi-sector memory request received includes a starting sector address and a number of sectors to be communicated. The multi-sector memory request is mapped into a series of single sector memory requests. The single sector requests are submitted to the memory device.

Another embodiment of the invention pertains to an electronic apparatus. The apparatus includes a processor, a memory system, an operating system in the memory system, a block driver in the operating system, a memory buffer, and a communication system configured to communicate with a flash memory controller. The block driver is configured to map a multi-sector memory request into a plurality of single-sector memory requests.

Other embodiments are also disclosed.

### BRIEF DESCRIPTION OF THE DRAWINGS

FIG. 1 is a flow chart depicting a conventional method of performing a multi-sector read from flash memory.

FIG. 2 is a flow chart depicting a conventional method of performing a multi-sector write to flash memory.

FIG. 3 is a flow chart depicting a method of performing a multi-sector read from flash memory in accordance with an embodiment of the invention.

FIG. 4 is a flow chart depicting a method of performing a multi-sector write to flash memory in accordance with an embodiment of the invention.

FIG. 5 is a schematic diagram of an apparatus for performing multi-sector reads from and writes to flash memory in accordance with an embodiment of the invention.

### DETAILED DESCRIPTION

The present disclosure provides a method and apparatus for improving the reliability and robustness of certain flash memory storage systems and their utilization. In particular, the present disclosure provides a solution for certain flash memory storage systems which may at times fail to properly perform multi-sector reads and multi-sector writes.

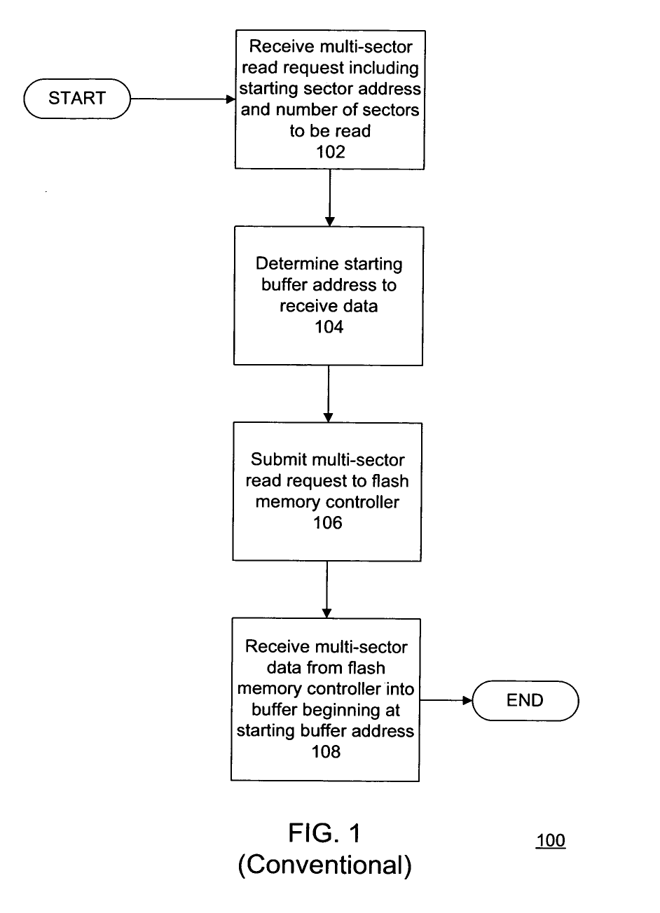

FIG. 1 is a flow chart depicting a conventional method 100 of performing a multi-sector read from flash memory. The multi-sector read function relates to the reading of data from a contiguous multiple sector portion of the flash memory address space.

A multi-sector read request is received 102. The multi-sector read request includes a starting sector address and the number of contiguous sectors to be read beginning from that starting sector address. The multi-sector read request may be received, for example, by a device driver from a software application executing on the system. The software application may send the request, for example, by way of an application programming interface (API) of a real-time operating system. The device driver may be a block driver (as opposed to a character driver) configured to interface with the flash memory controller.

A determination 104 is then made as to the starting address within a buffer memory (“the starting buffer address”) for receiving the data to be read. This determination may be initiated by the device driver in the operating system. The buffer memory may comprise static random access memory (SRAM) or other type of memory.

The multi-sector read request may then be submitted 106 by the device driver to the flash memory controller. The read request identifies the starting sector address and the number of contiguous sectors to be read beginning at that starting sector address.

The requested data is then received 108 from the flash memory controller into the buffer memory beginning at the starting buffer address. The received data may then be accessed from the buffer. Unfortunately, as mentioned above, such multi-sector reads may sometimes be unreliable when actually executed by a flash memory storage system.

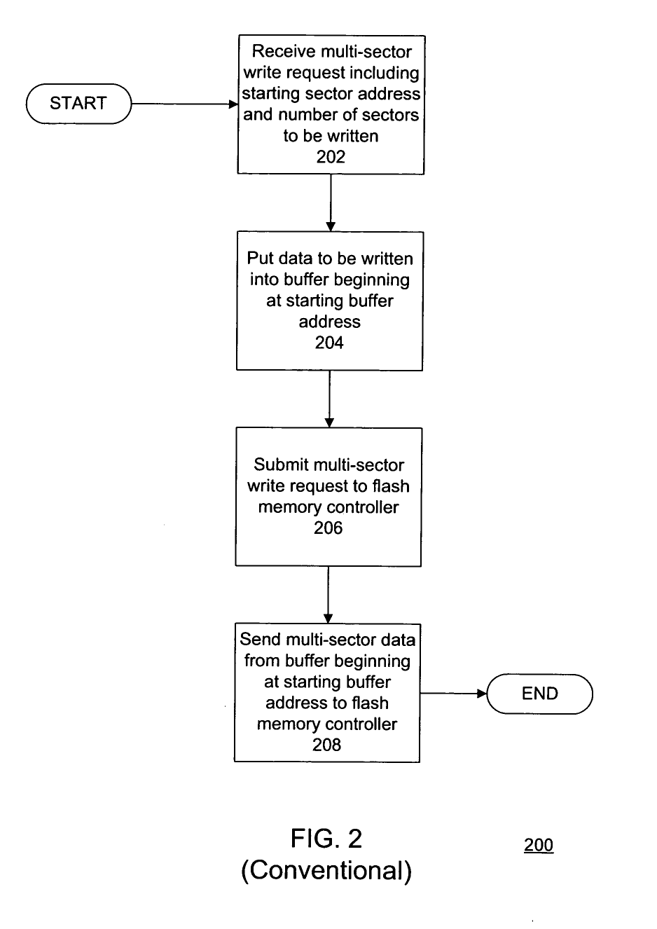

FIG. 2 is a flow chart depicting a conventional method 200 of performing a multi-sector write to flash memory. The multi-sector write function relates to the writing of data to a contiguous multiple sector portion of the flash memory address space.

A multi-sector write request is received 202. The multi-sector write request includes a starting sector address and the number of contiguous sectors to be written beginning from that starting sector address. The multi-sector write request may be received, for example, by a device driver from a software application executing on the system. The software application may send the request, for example, by way of an application programming interface (API) of a real-time operating system. The device driver may be a block driver (as opposed to a character driver) configured to interface with the flash memory controller.

A determination is then made as to the starting address within a buffer memory (“the starting buffer address”) for holding the data to be written, and the data to be written is put 204 into the buffer beginning at that starting buffer address. This determination may be initiated by the device driver in the operating system. The buffer memory may comprise static random access memory (SRAM) or other type of memory.

The multi-sector write request may then be submitted 206 by the device driver to the flash memory controller. The write request identifies the starting sector address and the number of contiguous sectors to be written beginning at that starting sector address.

The requested data is then sent 208 from the buffer memory beginning at the starting buffer address to the flash memory controller. The data sent may then be written by the flash memory controller to the flash memory media beginning at the starting sector address. Unfortunately, as mentioned above, such multi-sector writes may sometimes be unreliable when actually executed by a flash memory storage system.

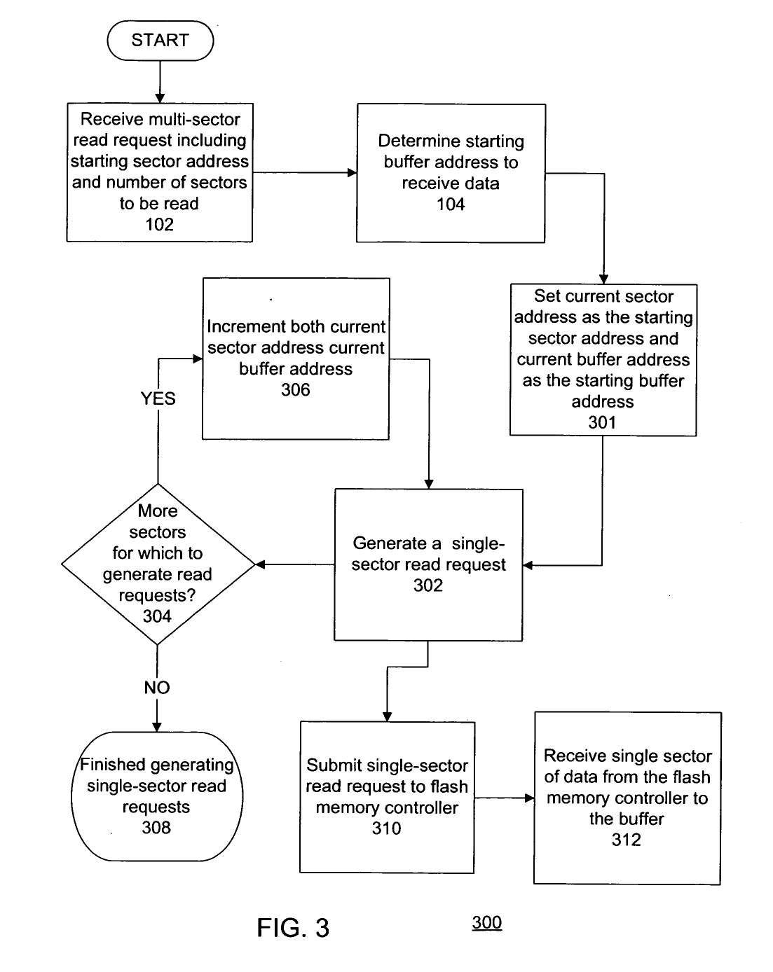

FIG. 3 is a flow chart depicting a method 300 of performing a multi-sector read from flash memory in accordance with an embodiment of the invention. Again, the multi-sector read function relates to the reading of data from a contiguous multiple sector portion of the flash memory address space.

Like in the conventional method 100, a multi-sector read request is received 102. The multi-sector read request includes a starting sector address and the number of contiguous sectors to be read beginning from that starting sector address. Also like in the conventional method 100, a determination 104 is made as to the starting address within a buffer memory (“the starting buffer address”) for receiving the data to be read. However, thereafter, the method 300 disclosed herein differs from the conventional method 100.

Instead of submitting 106 a multi-sector read request per the conventional method 100, the method 300 disclosed herein sets 301 a current sector address to be the starting sector address and a current buffer address to be the starting buffer address.

A single-sector read request based on the current sector address and the current buffer address is then generated 302 by the device driver. The single-sector read request identifies the sector address to be read as the current sector address, but it does not need to identify a number of contiguous sectors to be read because only one sector is being read. The single-sector read request may then be submitted 308 by the device driver to the flash memory controller. After processing by the flash memory controller, the single sector of data is received 312 from the flash memory controller into the identified buffer address.

In addition, after generating 302 the single-sector read request, a determination 304 may be made as to whether more sectors are to be read; more particularly, whether or not there are further sectors from the multi-sector read request for which single-sector read requests have not yet been generated.

If there are more sectors for which to generate read requests, then both the current sector address and the current buffer address are incremented 306. The current sector address is incremented by one (for example, from sector 0 to sector 1, or more generally from sector n to sector n+1). The current buffer address is incremented by the size of a single sector. Thereafter, the method 300 loops back and a next single-sector read request is generated 302.

The generation of single-sector read requests continues until a single-sector read request has been generated for each sector encompassed by the original multi-sector read request. When single-sector read requests have been generated for each sector encompassed by the original multi-sector read request, then the method 300 is finished generating the single-sector read requests 308.

Each single-sector read request generated 302 is submitted 310 to the flash memory controller. The requested single-sector data is subsequently received 312 from the flash memory controller into the buffer memory beginning at the identified buffer address (i.e. the current buffer address identified with that particular request). After all the series of single-sector data is received by the buffer, then the contiguous multi-sector data may be accessed from the buffer beginning at the starting buffer address.

The above-described technique 300 maps a sometimes less robust multi-sector read request into a series of typically more robust single-sector read requests. This advantageously may improve the reliability of reading data from the multiple sectors. The trade-off is that the performance or speed of reading the data may be reduced. However, applicant has determined that for multi-sector read requests where the number of sectors is relatively low (for example, on the order of 10 sectors, or below approximately 100 sectors), the performance penalty may be insubstantial when weighed against the improved reliability.

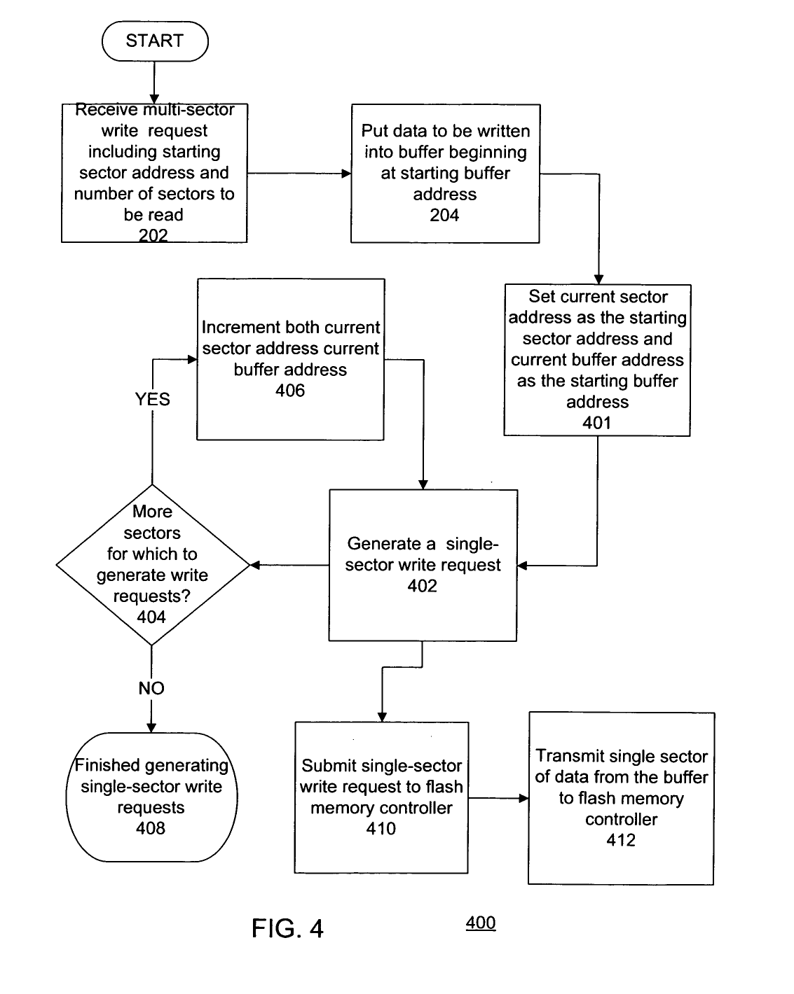

FIG. 4 is a flow chart depicting a method 400 of performing a multi-sector write to flash memory in accordance with an embodiment of the invention. Again, the multi-sector write function relates to the writing of data to a contiguous multiple sector portion of the flash memory address space.

Like in the conventional method 200, a multi-sector write request is received 202. The multi-sector write request includes a starting sector address and the number of contiguous sectors to be written beginning from that starting sector address. Also like in the conventional method 200, a determination is made as to the starting address within a buffer memory (“the starting buffer address”) for holding the data to be written, and the data to be written is put 204 into the buffer beginning at that starting buffer address. However, thereafter, the method 400 disclosed herein differs from the conventional method 200.

Instead of submitting 206 a multi-sector write request per the conventional method 200, the method 400 disclosed herein sets 401 a current sector address to be the starting sector address and a current buffer address to be the starting buffer address.

A single-sector write request based on the current sector address and the current buffer address is then generated 402 by the device driver. The generation may be performed by the deviced driver. The single-sector write request identifies the sector address to be written, but it does not need to identify a number of contiguous sectors to be written because only one sector is being written. The single-sector write request may then be submitted 410 by the device driver to the flash memory controller. The single sector of data is then transmitted 412 from the buffer to the flash memory controller.

In addition, after generating 402 the single-sector write request, a determination 404 is made as to whether more sectors are to be written; more particularly, whether or not there are further sectors from the multi-sector write request for which single-sector write requests have not yet been generated.

If there are more sectors for which to generate write requests, then both the current sector address and the current buffer address are incremented 406. The current sector address is incremented by one (for example, from sector 0 to sector 1, or more generally from sector n to sector n+1). The current buffer address is incremented by the size of a single sector. Thereafter, the method 400 loops back and a next single-sector write request is generated 402.

The generation of single-sector write requests continues until a single-sector write request has been generated for each sector encompassed by the original multi-sector write request. When single-sector write requests have been generated for each sector encompassed by the original multi-sector write request, then the method 400 is finished generating the single-sector write requests 408.

Each single-sector write request generated 402 is submitted 410 to the flash memory controller. The requested single-sector data is subsequently transmitted 410 to the flash memory controller from the buffer memory beginning at the identified buffer address (i.e. the current buffer address identified with that particular request). After all the series of single-sector data is sent to the flash memory controller and written to the flash memory media, then the contiguous multi-sector data is held in the flash memory media beginning at the starting buffer address.

The above-described technique 400 maps a sometimes less robust multi-sector write request into a series of typically more robust single-sector write requests. This advantageously may improve the reliability of writing data to the multiple sectors. The trade-off is that the performance or speed of writing the data may be reduced. However, applicant has determined that for multi-sector write requests where the number of sectors is relatively low (for example, on the order of 10 sectors, or below approximately 100 sectors), the performance penalty may be insubstantial when weighed against the improved reliability.

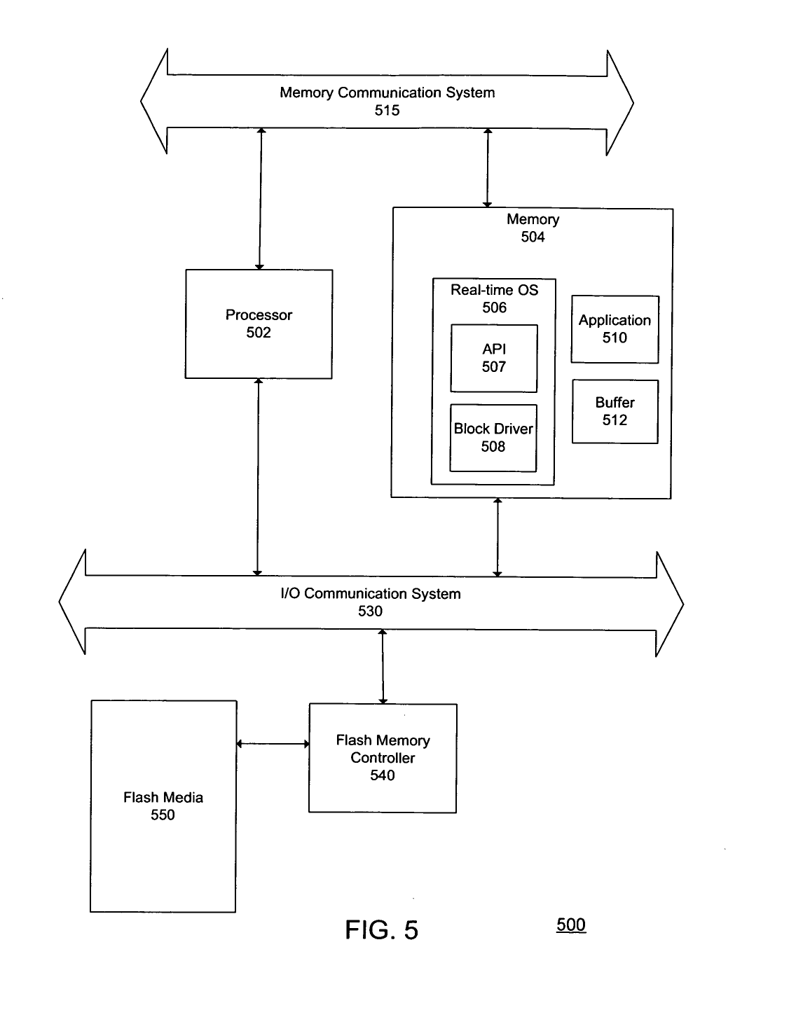

FIG. 5 is a schematic diagram of an apparatus 500 for performing multi-sector reads from and writes to flash memory in accordance with an embodiment of the invention. The apparatus 500 illustrated includes a processor 502, memory 504, a memory communication system 515, an input/output (I/O) communication system 530, a flash memory controller 540, and flash media 550. Other specific apparatus configurations may be implemented in accordance with other embodiments of the invention.

The memory 504 may be communicatively coupled to the processor 502 by way of the memory communication system 510. The memory 504 may be configured to include various software components, including a real-time operating system (OS) 506 and one or more software applications 510. Buffer memory 512 may also be included. The real-time OS 506 may include various components, including an application programming interface (API) 507 and a block driver 508 among other drivers.

As pertaining to the present disclosure, a software application 510 may originate a multi-sector read or write request. The OS 506 may receive the multi-sector request by way of the API 507. The block driver 508 may be configured so as to map the multi-sector request to single-sector requests as discussed above in relation to FIG. 3 (for read requests) or FIG. 4 (for write requests). These single-sector requests may be sent to the flash memory controller 540 by way of the I/O communication system 530.

In a specific embodiment of the invention, the apparatus 500 comprises part of a network switching system. The real-time OS 506 may comprise a version of the VxWorks™ operating system from Wind River Systems of Alameda, Calif. The flash memory storage system may comprise a form of CompactFlash™, and the I/O communication system 530 may comprise an ATA/IDE bus.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A method of performing a multi-sector memory request for data to be communicated with a memory device, the method comprising:
receiving the multi-sector memory request which includes a starting sector address and a number of sectors to be communicated;
mapping the multi-sector memory request into a series of single sector memory requests; and
submitting the single sector requests to the memory device.

2. The method of claim 1, wherein said mapping includes incrementing both a current sector address and a current buffer address.

3. The method of claim 2, wherein the current sector address is initially set to the starting sector address, and the current buffer address is initially set to the starting buffer address.

4. The method of claim 3, wherein the number of sectors to be communicated is N, and wherein said incrementing is performed (N−1) times so as to perform said mapping.

5. The method of claim 1, wherein the multi-sector memory request is a multi-sector read request.

6. The method of claim 1, wherein the multi-sector memory request is a multi-sector write request.

7. The method of claim 1, wherein the memory device comprises a flash memory device.

8. An electronic apparatus, the apparatus comprising:
a processor;
a memory system;
an operating system in the memory system;
a block driver in the operating system;
a memory buffer; and
a communication system configured to communicate with a flash memory controller,
wherein the block driver is configured to map a multi-sector memory request into a plurality of single-sector memory requests.

9. The apparatus of claim 8, wherein said mapping includes incrementing both a current sector address and a current buffer address.

10. The apparatus of claim 9, wherein the current sector address is initially set to the starting sector address, and the current buffer address is initially set to the starting buffer address.

11. The apparatus of claim 10, wherein the number of sectors to be communicated is N, and wherein said incrementing is performed (N−1) times so as to perform said mapping.

12. The apparatus of claim 8, wherein the multi-sector memory request is a multi-sector read request.

13. The apparatus of claim 8, wherein the multi-sector memory request is a multi-sector write request.

14. An apparatus configured to transmit a multi-sector memory request for data to be communicated with a memory device, the apparatus comprising:
a software application originating the multi-sector memory request which includes a starting sector address and a number of sectors to be communicated;
a device driver configured to receive the multi-sector memory request from the software application;
processor-executable instructions of the device driver configured to map the multi-sector memory request into a series of single sector memory requests; and
processor-executable instructions of the device driver configured to transmit the single sector requests to the memory device.

15. The apparatus of claim 14, wherein said mapping includes incrementing both a current sector address and a current buffer address.

16. The apparatus of claim 14, wherein the current sector address is initially set to the starting sector address, and the current buffer address is initially set to the starting buffer address.

17. The apparatus of claim 16, wherein the number of sectors to be communicated is N, and wherein said incrementing is performed (N−1) times so as to perform said mapping.

18. The apparatus of claim 14, wherein the multi-sector memory request is a multi-sector read request.

19. The apparatus of claim 14, wherein the multi-sector memory request is a multi-sector write request.

20. The apparatus of claim 14, wherein the memory device comprises a flash memory device.
